(19) United States
(12) Patent Application Publication
(10) Pub. No.: US 2010/0299589 A1
(43) Pub. Date: Nov. 25, 2010

(54) KEYWORD DISPLAY METHOD AND KEYWORD DISPLAY SYSTEM

(75) Inventor: Ikuya Yamada, Machida-shi (JP)

Correspondence Address: Workman Nydegger;1000 Eagle Gate Tower, 60 East South Temple, Salt Lake City, UT, 84111, US

(73) Assignee: Studio Ousia Inc., Tokyo (JP)

(21) Appl. No.: 12/782,575

(22) Filed: May 18, 2010

(30) Foreign Application Priority Data
May 19, 2009 (JP) 2009-121061
May 14, 2010 (JP) 2010-111798

(51) Int. Cl. G06F 17/00

(52) U.S. Cl. 715/235; 715/234

(57) ABSTRACT

To display information that is related to a keyword described on a webpage. A keyword display method includes a first step of listing DOM (Document Object Model) nodes according to a DOM definition, and extracting text from an HTML document of the webpage; a second step of extracting a word, which matches a word stored in a pre-registered dictionary, as a keyword from the extracted text; and a third step of changing a DOM node of the extracted keyword.

This application claims the benefit of Japanese Patent Application Nos. 2009-121061, filed May 19, 2009, and 2010-111798, filed May 14, 2010, which are hereby incorporated by reference herein in their entirety.

### BACKGROUND OF THE INVENTION

1. Field of the Invention

The present invention relates to a keyword display method and a keyword display system, and more particularly to a keyword display method and a keyword display system that provide information related to a keyword that is described on a webpage displayed by a web browser.

2. Description of the Related Art

A web browser is an application program that is installed in a client terminal and acquires a resource from a web server having a specified URL (Uniform Resource Locator) to display it on a display device of the client terminal. The web browser has three functions, that is, a user agent, parser, and renderer. After receiving a request from a user, the user agent performs communication with a web server having a specified URL using, for example, HTTP (Hyper Text Transfer Protocol) to send the user request. In addition, the user agent acquires a resource corresponding to the user request from the web server. The parser analyzes content of the resource according to the type of the acquired resource. For example, when the resource is a webpage that is written using HTML (Hyper Text Markup Language), the parser analyzes a structure of the acquired HTML document while referencing elements that are separated by tags. The renderer adjusts the sizes and colors of text, graphics, images, and the like based on a result of the analysis by the parser, creates a screen in which the elements defined by the HTML document are arranged in suitable positions, and displays the screen on the display device of the client terminal.

Moreover, it is known that by installing various plugins in the web browser, it is possible to expand the functions of the web browser (for example, see a webpage “http://www.mozilla.org”). A plugin is a kind of program that is added to an application program, and by switching plugins, it is possible to realize various functions. Parameters that are given to a plugin from the web browser, data received from a plugin, procedure for calling up a plugin, and the like are strictly defined and disclosed, so that a third party other than a web browser developer can expand the functions of the web browser.

The most characteristic thing when browsing a webpage using a web browser is that it is possible to browse different webpages one after the other by following hypertext links. More specifically, in a document written using HTML, it is possible to define text (hypertext) that is correlated (also referred to as “linked”) with a URL. When a user clicks on hypertext that is displayed on a screen of a client terminal, the web browser performs communication with a web server of the correlated URL, and acquires and displays a new resource.

For example, in an electronic shopping mall on the web server, the web browser displays a webpage that presents a catalog in which product names are listed. With the product name listed using hypertext, the product names are linked to product explanation screens for each product. Furthermore, the web browser displays an order button for changing to a product order screen, and the button is also linked to those screens. In this way, as the electronic shopping mall, by constructing the webpage hierarchically along the flow of searching products to order, a user can easily order products by simply moving a cursor with a mouse and clicking on a mouse button.

On the other hand, for example, suppose, on a webpage that introduces a certain product such as digital cameras, the item “Valid Pixels” and a numerical value indicating the number of pixels are displayed in the product specifications. At this time, also suppose it is feasible that the user will not understand the technical meaning of the keyword “Valid Pixels”. It is also possible to add, in an electronic shopping mall, a link to a webpage describing the definition of the term “Valid Pixels” as hypertext. However, by providing an explanation screen for each term listed in the product specifications, a volume of the webpage is increase, so that it is not possible to add links to all terms. Therefore, the user must input the keyword “Valid Pixels” using a search engine to search other webpages, or webpages that are dictionaries of technical terms, or must search for the meaning of the keyword using some other method (for example, paper dictionaries). As a result, there is a problem in that for the user, browsing the webpage becomes inconvenient.

### SUMMARY OF THE INVENTION

The present invention is made in consideration of this kind of problem, and an object thereof is to provide a keyword display method and a keyword display system that display only information related to a keyword described on a webpage.

To accomplish this object, an invention according to claim 1 is a keyword display method for displaying a pre-registered keyword from a webpage, the method includes: a first step of listing DOM (Document Object Model) nodes based on a DOM definition, and extracting text from an HTML document of the webpage; a second step of extracting a word, which matches a word that is stored in a pre-registered dictionary, as a keyword from the extracted text; and a third step of changing a DOM node of the extracted keyword.

The third step creates a new DOM node that includes the extracted keyword, and replaces the keyword in the HTML document therewith. Then, the third step defines an event handler in a tag of the new DOM node in order to display another webpage that has information related to the keyword.

The keyword display method may further comprise a fourth step of displaying information, which has the information related to the keyword, over the webpage by defining an event handler in the tag of the new DOM node. The keyword display method may further comprise: a fifth step of acquiring a CSS (Cascading Style Sheet) definition that corresponds to the keyword in the HTML document; and a sixth step of setting the acquired definition as a CSS definition corresponding to the new DOM node.

An invention according to claim 8 is a keyword display system for displaying a pre-registered keyword from a webpage that is acquired from a web server, the system comprises: a web browser that includes a user agent, a parser, and a renderer; and a plugin that includes a dictionary pre-registered with a word, and a keyword markup module that acquires an HTML document of the webpage from the user agent; lists DOM (Document Object Mode) nodes based on a DOM definition and extracts text; extracts a word, which matches a word that is stored in the dictionary, as a keyword from the text; changes a DOM node of the extracted keyword; and gives a result to the renderer.

According to the present invention, it is possible to extract and display a pre-registered keyword by changing a DOM node with respect to the keyword on a webpage. In addition, by defining an event handler in a tag of the new DOM node, it is possible to display information related to that keyword.

Further features of the present invention will become apparent from the following description of exemplary embodiments (with reference to the attached drawings).

### BRIEF DESCRIPTION OF THE DRAWINGS

FIG. 1 is a diagram illustrating a server-client system according to one embodiment of the present invention;

FIG. 2 is a block diagram illustrating a configuration of a web browser according to one embodiment of the present invention;

FIGS. 3A and 3B are a diagrams illustrating an example of a webpage according to one embodiment of the present invention;

FIG. 4 is a diagram illustrating an example of an HTML document that is a resource of the webpage;

FIG. 5 is a diagram illustrating a keyword display method according to a first embodiment of the present invention;

FIG. 6 is a diagram of a first example illustrating a method for rewriting a DOM node;

FIG. 7 is a diagram of a second example illustrating the method for rewriting a DOM node;

FIG. 8 is a diagram of a third example illustrating the method for rewriting a DOM node;

FIG. 9 is a diagram of a fourth example illustrating the method for rewriting a DOM node; and

FIG. 10 is a diagram illustrating a method for displaying information related to a keyword.

### DESCRIPTION OF THE EMBODIMENTS

Embodiments of the present invention will be described in detail below with reference to the drawings.

### First Embodiment

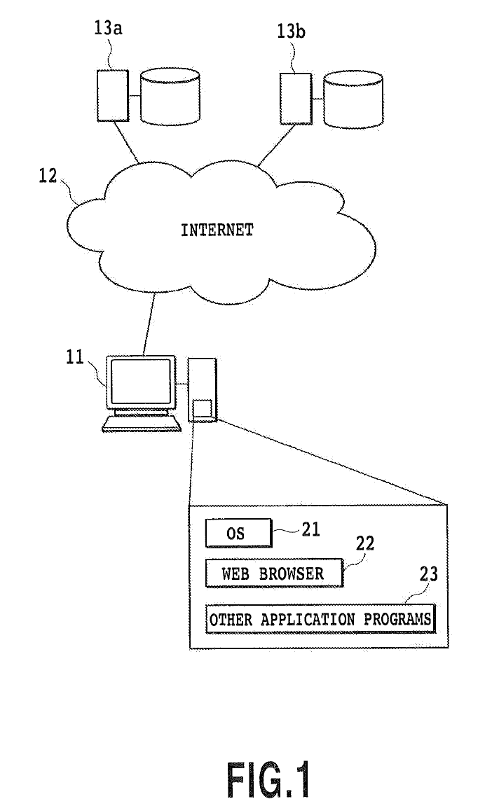

FIG. 1 illustrates a server-client system according to one embodiment of the present invention. A client terminal 11 is connected to web servers 13a and 13b via the Internet 12. An operating system (OS) 21, web browser 22, and other various application programs 23 are installed in a storage medium of the client terminal 11. At the same time that the client terminal 11 is started up, the OS 21 is expanded in memory, and a program stored in the storage medium is expanded in memory and executed. Here, an example is described, in which the client terminal 11 acquires a document described in HTML from the web server 13a, and displays a webpage on a display device of the client terminal 11.

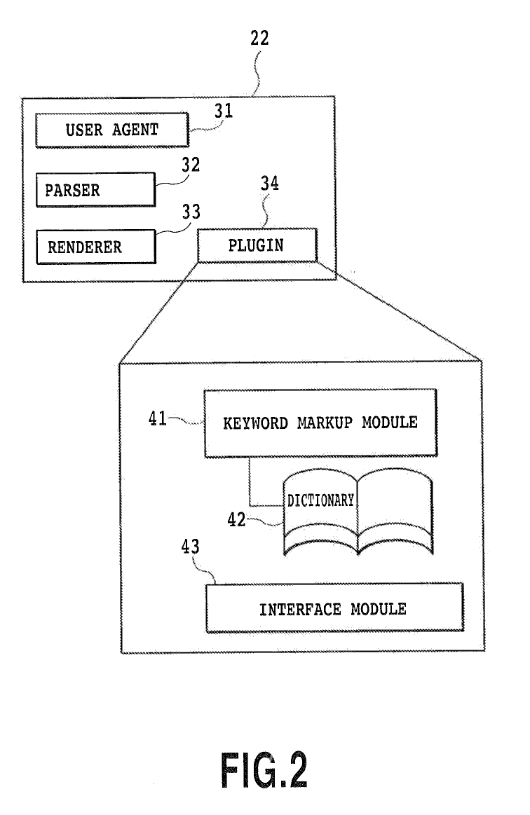

FIG. 2 illustrates a configuration of the web browser according to one embodiment of the invention. The web browser 22, which is one of the application programs, includes a user agent 31, parser 32, renderer 33, and plugin 34. Furthermore, the plugin 34 according to the first embodiment has: a dictionary 42 pre-registered with keywords for which related information to be displayed; a keyword markup module 41 that extracts and marks up a registered keyword from an HTML document; and an interface module 43 that provides a decorative display of the marked up keyword, or displays information related to the keyword.

With this kind of configuration, a user of the client terminal 11 starts up the web browser 22, and inputs a URL of a desired resource to browse. The user agent 31 of the web browser 22 accesses the web server 13a for the specified URL to acquire an HTML document. The parser 32 analyzes a structure of the acquired HTML document. At this time, the user agent 31 calls up the plugin 34 to execute a keyword display method according to one embodiment of the present invention in parallel with processing by the parser 32 and renderer 33. The renderer 33 displays a webpage on the display device of the client terminal 11 based on a result of the analysis by the parser 32. This will be described in more detail later, however, in the webpage that is displayed on the client terminal 11, keywords that are registered in the dictionary 42 are marked up, and when the user selects a keyword, information related to that keyword is displayed.

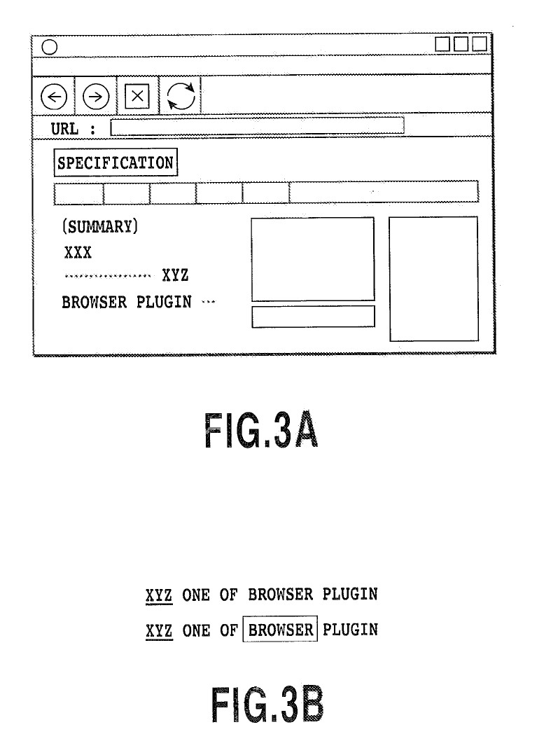

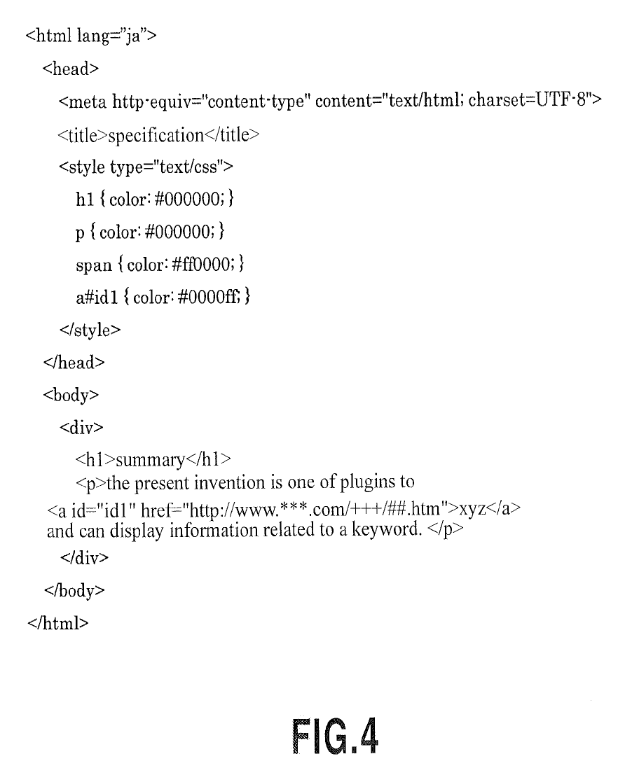

FIGS. 3A and 3B illustrate an example of a webpage according to one embodiment of the present invention. FIG. 4 illustrates an example of an HTML document that is a resource for this webpage. The HTML document specifies a structure of the document by classifying plain text into various “elements” and defines those elements. An “element” is expressed by:
start tag <element name> content end tag </element name>

For example, as illustrated in FIG. 4, an element ‘title’ is expressed in the HTML document using a start tag and end tag as <title> Specification </title>. Content of the element ‘title’ is “Specification”.

Moreover, an attribute can be defined inside the start tag. In the example in FIG. 4, for an element ‘a’, an attribute is defined in the start tag. The attribute is a URL that indicates another webpage related to the content “XYZ” of the element, and is defined as “href=”http://www.***.com/+++/##.htm”. That is, the element ‘a’ is linked as hypertext. In this way, it is possible to add various functions to an element by setting an attribute such as ‘href’ in a start tag, or by calling up an arbitrary function by setting an event handler using Javascript (script language for a web browser) or the like.

As a webpage, web browser, or plugin is developed, a DOM (Document Object Model) is defined as an application interface for analyzing and controlling an HTML document. The DOM handles an HTML document as a tree structure, and defines an “element” defined by the HTML document as a “DOM node”. With a parser in which a DOM has been installed, it is possible to access a DOM node as an object in which attributes, methods, and events have been embedded in order to create or control a webpage.

In order to display a document described in the HTML on a display device, a text size, font, layout, and the like must be set. In order to separate the structure and format of the document, attributes that influence the appearance like this are defined by CSS (Cascading Style Sheet). The CSS is defined by a
selector {property: value}
   collection called a rule collection (also called a style sheet). The selector specifies an element (DOM node) of an HTML document, and a declarative block comprising {property: value} sets an attribute of the element. The DOM node is defined by class and an identifier (ID), and for example, in the example of FIG. 4,
a#id1{color: #0000ff; }
   indicates an element ‘a’ whose identifier=#id1. The above declarative block expresses the color of text, and specifies RGB (every 8 bits is expressed in approximately 16.7 million colors, with every 8 bits being represented in hexadecimal notation) to turn the text blue. In this way, for example, it is possible to display the blue text “XYZ” of the hypertext element ‘a’ inside a document that is written in black text (element p in the example of FIG. 4) (in the example of FIG. 3B, the text is underlined instead of using the color blue).

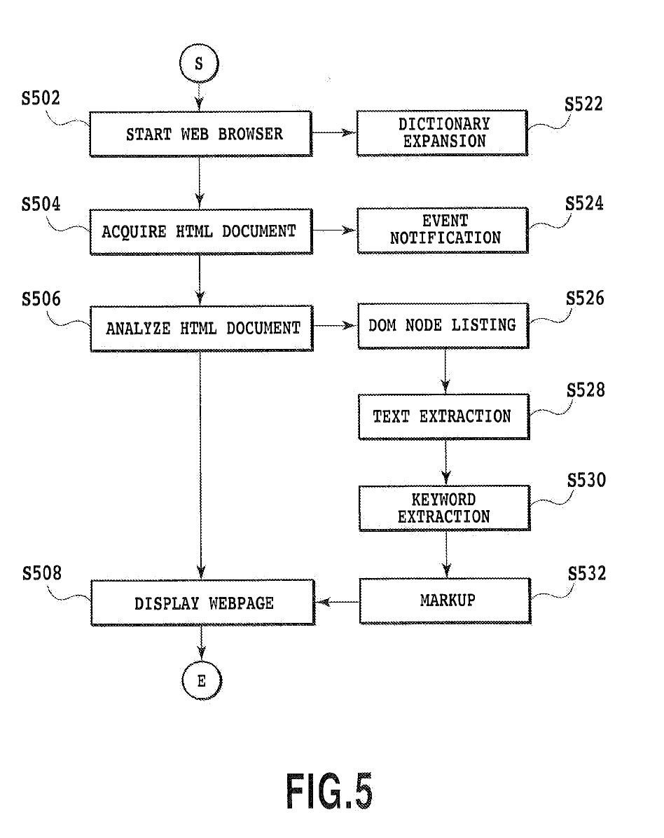

FIG. 5 illustrates the keyword display method according to the first embodiment of the present invention. After the web browser 22 is started up on the client terminal 11 (S502), the user agent 31 calls up the plugin 34, and the dictionary 42 is expanded in the memory of the client terminal 11 (S522). Note that it is also possible to register keywords, for which related information is to be displayed, in the web server 13a beforehand (see a second embodiment). This method has an advantage in that it is possible for the web server 13a to markup keywords beforehand in an HTML document that will be transmitted to the client terminal 11. However, in this method, a user can display related information only when accessing the web server retaining the keywords, but cannot display the related information when accessing a web server not retaining the keywords. According to the first embodiment, the client terminal 11 has the dictionary, so that regardless of whether or not the web server retains keywords, related information can be displayed when any web server is accessed, and therefore there is excellent user operability. In addition, it is possible to use a TRIE (ordered tree structure) dictionary, a hash structure dictionary, or the like as the dictionary 42 (see a fourth embodiment).

When the user agent 31 acquires an HTML document (S504), and displays a webpage, the user agent 31 notifies the plugin 34 of an event, and calls up the plugin 34 (S524).

The parser 32 performs analysis of the HTML document (S506), and at the same time that the renderer 33 displays the webpage (S508), markup of keywords is performed. More specifically, the parser 32 analyzes a structure of the HTML document acquired by the user agent 31, and at the same time that the rendering process is performed, the keyword markup module 41 lists DOM nodes that correspond to elements in the HTML document according to the tree structure defined by the DOM (S526). That is, the keyword markup module 41 lists the DOM nodes using, for example, ‘getElementsByTagName’, ‘createTreeWalker’, or the like that is defined as DOM API.

Next, the keyword markup module 41 extracts text from the listed DOM nodes (S528). In the example of FIG. 4, the keyword markup module 41 extracts the text from the HTML document from <body> at the top to <div> at the bottom, while sequentially listing DOM nodes according to the tree structure defined by the DOM.

The keyword markup module 41 then searches the dictionary 42 based on the extracted text to extract keywords (S530). Here, it is assumed that the term “plugin” is registered in the dictionary 42 as a keyword for which related information is to be displayed. It is possible to use a method such as common morphological analysis, or a method of repeatedly applying the longest match method from the first word of the text. The DOM nodes (HTML elements) are rewritten with the extracted keywords by the keyword markup module 41 (S532), and given to the renderer 33. This is explained in detail below.

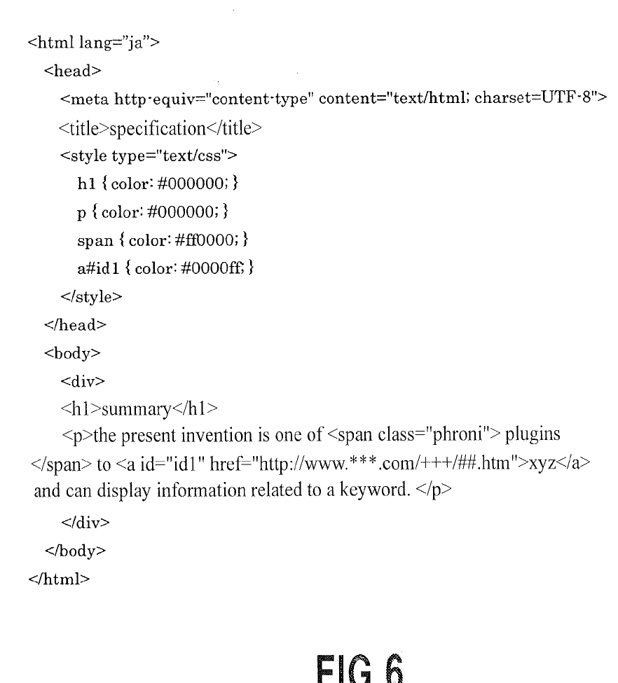

FIG. 6 illustrates a method for rewriting the DOM nodes. By setting new tags for the extracted keywords, or rewriting tags, the keyword markup module 41 creates or changes the DOM nodes. For example, it is assumed that the term “plugin” is registered in the dictionary 42, and extracted by the keyword markup module 41 from the HTML document that is the webpage resource. As illustrated in FIG. 6, the interface module 43 creates a new DOM node that includes the keyword “plugin”, and performs markup by replacing the original keyword in the HTML document.

At this time, if creating the new DOM node over an existing DOM node, the CSS of the existing DOM node may not necessarily be properly inherited. This is because, as was described above, the CSS specifies an attribute of an element using a tag or identifier (ID), and therefore the new DOM node may correspond to another CSS that differs from the CSS defined for the existing DOM node. In such a case, a font size, color or the like of the newly inserted DOM node could differ from that of the existing DOM node, which could interfere with the display. More specifically, the HTML document of FIG. 6 indicates that in the example of FIG. 4, a new DOM node <span> is created for the keyword “plugin” in the element p (black text). When doing this, the <span> DOM node corresponds to the CSS definition for the element ‘span’ illustrated in FIG. 4:
span{color: #ff0000; },
   and therefore the CSS definition for the element p:
p{color: #000000; }
   is not inherited. As a result, when the markup process is performed, the keyword is displayed in an unintended different color (in this case, the color red).

Therefore, (1) it is necessary to perform the markup process in a format such that as much as possible there is no competition with a CSS specified beforehand by a webpage; (2) when there is competition with some CSS, the CSS should be overwritten in order that there be no interference with the display; or (3) in the case of a CSS attribute that is likely to interfere with the display, it is necessary to instruct the web browser to forcibly inherit the CSS attribute.

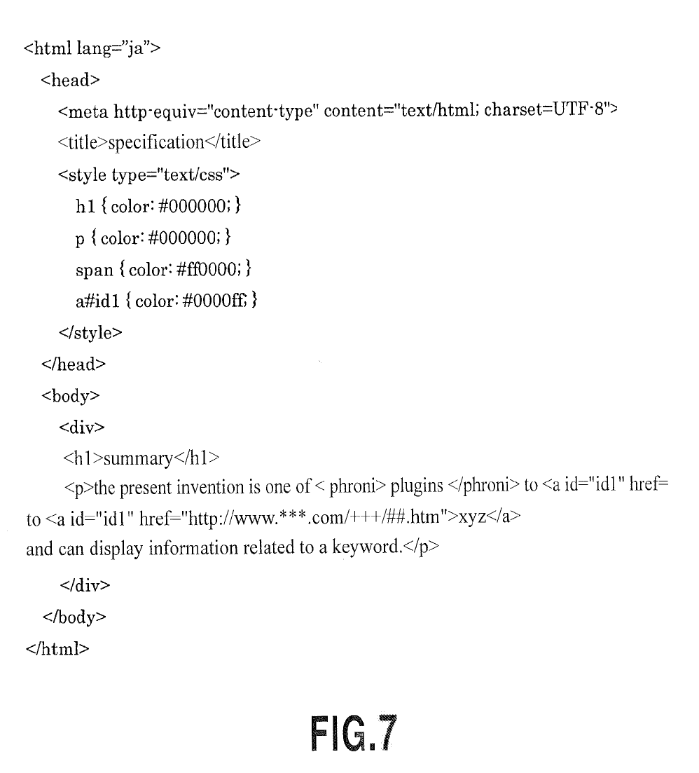

Atypical HTML document is described in a format that complies to the W3C (World Wide Web Consortium) standard, and the kinds of tags that can be used are set. Therefore, in the case of (1) above, by performing the markup process using a tag with a unique name such as “phroni” instead of using the tag “span” as shown in FIG. 7, competition with the definition of the existing CSS is avoided. On the other hand, even in the case where a unique tag is written in the acquired HTML document, the web browser is able to recognize the tag as a DOM node and properly display it as part of the webpage.

Moreover, ‘getComputedValue’ that acquires a CSS style attribute is defined as DOM API. Therefore, in the case of (2) above, after the DOM rendering process ends, the interference is avoided by using this API to acquire the CSS style attribute of the DOM node of the inserted destination, and to set that CSS style attribute for a new DOM node as well.

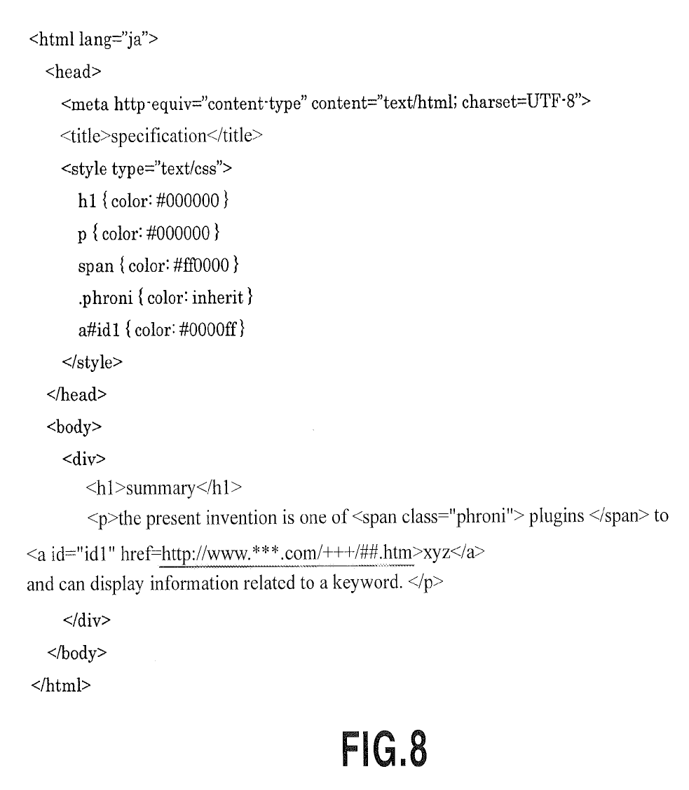

Furthermore, in the case of (3) above, the interference is avoided by instructing the web browser to force the inheritance by specifying “inherit” for an attribute that is likely to interfere with the display. In FIG. 8, competition is avoided by specifying ‘inherit’ as described below for a ‘color’ attribute.
span{color: #ff0000}
.phroni{color: inherit}
   By setting a CSS with higher priority than the CSS of the inserted DOM node, it is possible to define a new style attribute for the new DOM node by overwriting the existing CSS style attribute.

In addition, in the CSS definition described above, the priority sequence used during the display is set depending on how the selector is selected. For example, a style attribute that is correlated with a low-order node is applied with higher priority than a style attribute correlated to the <head> or <body> node. Therefore, by directly setting a CSS style attribute for the style attribute of the inserted DOM node, it is possible to overwrite the existing CSS style attribute with high priority.

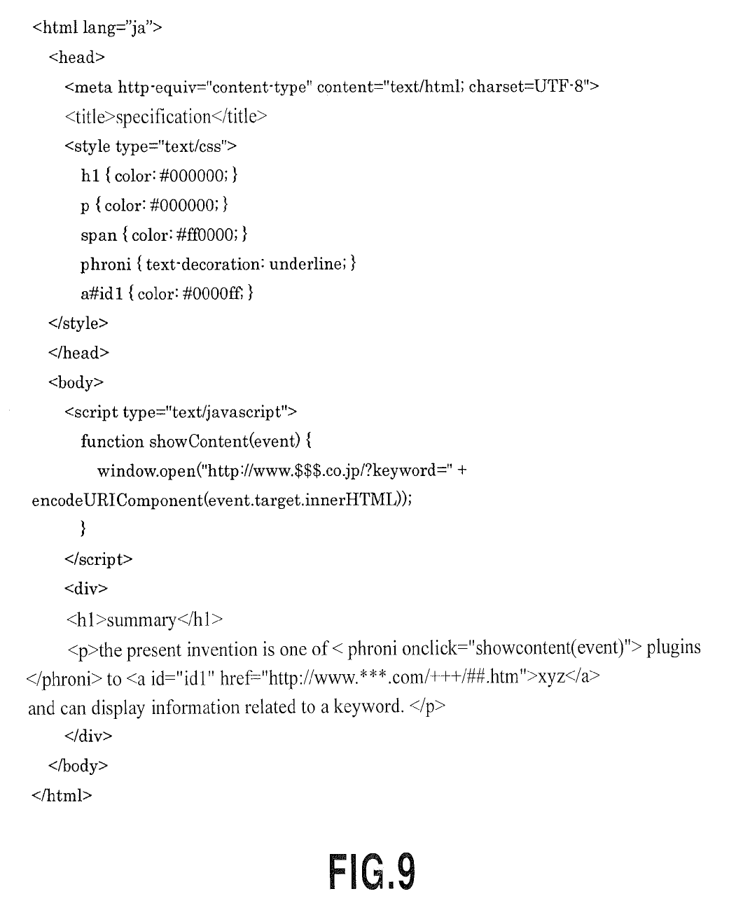

In the example of FIG. 4, it is desired that the keyword “plugin” for which related information will be displayed be distinguished by a display method that is different than the text in element ‘p’ that is black text, and the blue text that is set for the hypertext of element ‘a’. Therefore, as illustrated in FIG. 9, by defining the CSS
phroni{text-decoration: underline; }
   for the <phroni> tag, the text is displayed as underlined text. As described above, the renderer 33 displays the webpage on the display device of the client terminal 11 according to the rewritten DOM node and CSS style sheet.

Here, even though the <phroni> tag is a unique tag, an attribute can be defined in the start tag. Therefore, information related to a keyword is displayed by defining an event handler as an attribute in the start tag. The event handler is correlated with the keyword, and registered in the dictionary 42. As an example, an attribute for executing a function is defined in the start tag of the <phroni> tag as an ‘onclick’ attribute, and a process is described for that function to open a web version terminology dictionary, as illustrated in FIG. 9. It is also possible to define an attribute in the start tag to transmit a search request including the keyword to this web version terminology dictionary. When the user uses the mouse of the client terminal 11 to click on the keyword, a webpage for the web version terminology dictionary is displayed, or a webpage that shows search results for the keyword is displayed.

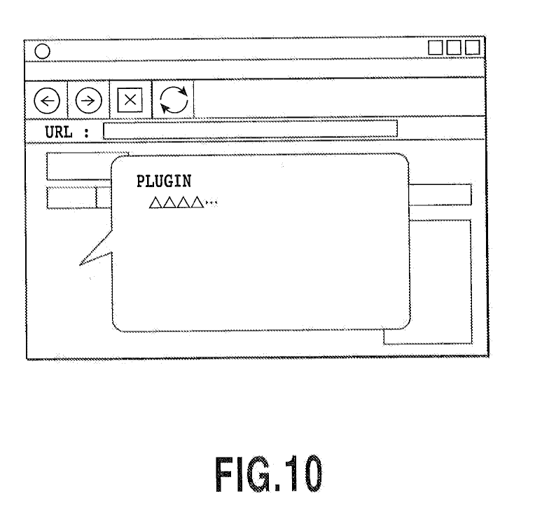

FIG. 10 illustrates a method for displaying information related to a keyword. When the user uses the mouse of the client terminal 11, or the like to select a keyword, the renderer 33 notifies the plugin 34 of an event that indicates that the keyword was selected. As illustrated in FIG. 9, the interface module 43 analyzes the attribute in the <phroni> tag, sends a search request including the keyword to the URL of the web version terminology dictionary, and acquires an explanation of the term that corresponds to the keyword in the web version terminology dictionary. After acquiring the webpage in which the explanation of the term is included, the interface module 43 extracts content such as text, HTML, or the like of the explanation of the term. The content is then inserted into a balloon type display pane as information related to the keyword, and displayed on the webpage in the form of an overlay. The overlay on the webpage is performed in the form of inserting a DOM node that is displayed as an overlay over an existing webpage.

According to the present embodiment, when a webpage including keywords that have been specified beforehand is displayed, the webpage is displayed so that it is obvious that the keywords have been registered. Moreover, when the user clicks on a keyword, only information related to the keyword is displayed.

### Second Embodiment

In the first embodiment, the client terminal 11 has the dictionary. As was described above, it is possible to register keywords, for which related information is to be displayed, in the web server 13a of a webpage provider. It is also possible for another business to have a dictionary in common with all users independently of the webpage provider. With this method, it is not necessary for each client terminal to store a large volume dictionary. In addition, by a webpage provider or other business actively registering beforehand keywords for which information is to be provided to a user, it is possible to use the keywords as an additional function such as a sales promotion in an electronic shopping mall.

This differs from the flow of the keyword display method according to the first embodiment in that in step S530 in FIG. 5, the keyword markup module 41 accesses and searches a dictionary of the web server 13a or 13b. The keyword markup module 41 searches the dictionary based on keywords that are included in extracted text, and when there is a matching keyword, acquires an event handler. The extracted keyword is rewritten in the DOM node (HTML element), and the event handler is added and given to the renderer 33 (S532).

### Third Embodiment

In a third embodiment, not only is a dictionary registered in the web server 13a, the plugin function described above is installed in the web server 13a. This method has the advantage in that the web server 13a can mark up keywords beforehand in an HTML document to be sent to the client terminal 11, and decrease a load of keyword processing in the client server.

When the web server 13a receives a user request from the client terminal 11, the web server 13a acquires a corresponding resource HTML document, and executes the processing of steps S526 to S532 of the flow illustrated in FIG. 5. A DOM node (HTML element) of an extracted keyword is rewritten, and the HTML document to which an event handler has been added is sent from the web server 13a to the client terminal 11.

### Fourth Embodiment

Keywords for which related information is to be displayed, and event handlers that correspond to the keywords are registered beforehand in the dictionary 42 of the first embodiment. It is possible to classify the keywords that are registered in the dictionary 42 according to category when registering the keywords. Categories for which the user desires to display related information can be set on an initial setup screen of the plugin 34 of the web browser 22. It is also possible to set the categories each time the web browser is started by displaying a window for setting categories.

The keyword markup module 41 searches only a specified category of the dictionary 42 according to extracted text, and extracts keywords for which related information is to be displayed. By marking up only the keywords that are included in a category specified by the user in this way, it is possible to reduce a load of the search process by the keyword markup module 41, as well as display keywords according to the desires of the user.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A keyword display method for displaying a pre-registered keyword from a webpage, comprising:
a first step of listing DOM (Document Object Model) nodes based on a DOM definition, and extracting text from an HTML document of said webpage;
a second step of extracting a word as a keyword from said extracted text, the word matching a word that is stored in a pre-registered dictionary; and
a third step of changing a DOM node of said extracted keyword.

2. The keyword display method according to claim 1, wherein words stored in the pre-registered dictionary are registered according to category, and wherein said second step extracts a word as a keyword according to pre-specified categories.

3. The keyword display method according to claim 1, wherein said third step creates a new DOM node that includes said extracted keyword, and replaces said keyword in said HTML document therewith.

4. The keyword display method according to claim 3, wherein said third step defines an event handler in a tag of said new DOM node in order to display another webpage that has information related to said keyword.

5. The keyword display method according to claim 3, further comprising a fourth step of displaying information over said webpage by defining an event handler in a tag of said new DOM node, the information having information related to said keyword.

6. The keyword display method according to claim 5, wherein said fourth step is executed based on a selection of a user for said new DOM node.

7. The keyword display method according to claim 1, further comprising:
a fifth step of acquiring a CSS (Cascading Style Sheet) definition that corresponds to said keyword in said HTML document; and
a sixth step of setting said acquired definition as a CSS definition corresponding to said new DOM node.

8. A keyword display system for displaying a pre-registered keyword from a webpage that is acquired from a web server, comprising:
a web browser that includes a user agent, a parser, and a renderer; and
a plugin that includes a dictionary pre-registered with a word, and a keyword markup module that acquires an HTML document of said webpage from said user agent; lists DOM (Document Object Mode) nodes based on a DOM definition and extracts text; extracts a word as a keyword from the text, the word matching a word that is stored in said dictionary; changes a DOM node of said extracted keyword; and gives a result to said renderer.

9. The keyword display system according to claim 8, wherein said keyword markup module creates a new DOM node that includes said extracted keyword, and replaces said keyword in said HTML document therewith.

10. The keyword display system according to claim 9, further comprising an interface module that executes an event based on an event handler that is defined in a tag of said new DOM node.
